(19) United States
(12) Patent Application Publication
(10) Pub. No.: US 2026/0149286 A1
(43) Pub. Date: May 28, 2026

(54) ELECTRIC SERVICE AND PANEL UPGRADE AVOIDANCE UTILIZING BATTERY ENERGY STORAGE AND MICROGRID INTERCONNECT DEVICE

(71) Applicant: Schneider Electric USA, Inc., Andover, MA (US)

(72) Inventors: Alex PIZNIUR, Vancouver (CA); Satish RAJAGOPALAN, Bellevue, WA (US); Nicolas MARC, Vancouver (CA); Jaser FARUQ, San Francisco, CA (US)

(73) Assignee: Schneider Electric USA, Inc., Andover, MA (US)

(21) Appl. No.: 18/961,408

(22) Filed: Nov. 26, 2024

(51) Int. Cl. H02J 3/38; H02J 3/32

(52) U.S. Cl. CPC H02J 3/388; H02J 3/32; H02J 2101/24; H02J 2105/12

(57) ABSTRACT

Systems/methods for controlling residential renewable energy systems, such as a home solar and storage power system, resolve or avoid overloading that could arise as a result of new loads/sources in the home or existing loads drawing too much power. The systems/methods provide a power control system (PCS) in the solar and storage power system that is configured to monitor the current in one or more busbars or other conductors in the home. If the current in the busbars or other conductors exceeds a predefined current threshold, then the PCS is configured to control the solar and storage power system to either supplement the current in the busbars or limit the current, and trip a microgrid interconnect device (MID) if other methods have been exhausted. This helps resolve or avoid overloading the power distribution system that could lead to unwanted overheating or tripping of an electrical panel breaker in the home.

### TECHNICAL FIELD

The present disclosure relates to solar and storage power systems, including electric vehicle (EV) vehicle-to-grid (V2G) systems, that supplement utility power for homes and other residential dwellings, and particularly to systems and methods for monitoring and controlling such solar and storage power systems based on the amount of electric current being consumed by various loads and produced by various sources in the home or residential dwelling.

### BACKGROUND

Home solar and storage power systems generally fall into one of the following categories: grid-tie non-backup systems, grid-tie backup systems, and off-grid systems. In any grid-tie system, solar power is typically used to power home loads first and excess power is sent to the power utility or “grid”, and the homeowner receives a credit that can be applied to offset the cost of grid power used in the home. Backup power systems are hybrid systems that can operate in grid-tie mode as well as operate in off-grid (grid-forming) mode when grid outage happens. When grid outage happens, the solar and storage power (including storage from EV) are used exclusively to power home loads while the system is completely disconnected from the grid by a microgrid interconnect device (MID). An off-grid system is a system designed to permanently operate off-grid and is never physically connected to the power utility.

A problem that can arise with solar and storage power systems is that the solar power added to the grid power along with new modern loads like heat pumps, EV chargers, and the like can overload the home electrical panel and/or busbar conductors. Accordingly, a need exists for a way to manage solar and other renewable energy systems along with added extra house loads.

### SUMMARY

Embodiments of the present disclosure relate to systems and methods for controlling residential renewable energy systems, such as a home solar and storage power system, to resolve or avoid overloading that could arise as a result of abnormal transient conditions like short circuit or normal steady state condition due to new loads in the home or existing loads drawing too much power. The systems and methods provide a power control system (PCS) in the home solar and storage power system that is configured to monitor the current in one or more busbars or other conductors in the home. If the amount of current in the one or more busbars or other conductors exceeds a predefined current threshold, then the PCS is configured control the solar and storage power system to either supplement the current in the busbars or limit the amount of current. This helps resolve or avoid overloading the electrical power distribution system of the home that could lead to unwanted tripping of an electrical panel main breaker in the home.

In some embodiments, the PCS is configured to use an incremental approach to controlling the home solar and storage power system. First, upon determining that the amount of current in one or more busbars or other conductors in the home exceeds a predefined current threshold, the PCS decreases charging or increased discharging of a battery of the solar and storage power system. Whether the PCS decreases charging of the battery or decreases discharging of the battery depends on whether the loads in the home are drawing too much power, or too much power is being sourced. Next, if the amount of current in the one or more busbars or other conductors continues to exceed the predefined current threshold, then the PCS completely exhausts charging or discharging of the battery. After that, if the predefined current threshold still continues to be exceeded, then the PCS opens a microgrid interconnect device (MID) or similar switching device of the solar and storage power system to partially or fully disconnect the system from the grid. Opening the MID or similar switching device in this way allows certain loads (i.e., non-backed-up loads), if present, to continue being powered from the grid, while forcing other loads (i.e., backed-up loads), if present, to start being powered exclusively from the solar and storage power system. The above arrangement helps resolve or avoid overloading the electrical power distribution system of the home as a result of new loads or existing loads drawing too much power, or to too much power being sourced to the home.

In general, in one aspect, embodiments of the present disclosure relate to a power control system (PCS) for a renewable energy system at a home. The power control system comprises, among other things, a processor and a storage unit coupled to the processor. The storage unit stores computer-readable instructions thereon that, when executed by the processor, cause the PCS to perform a process that obtains load currents at the home on a continuous basis, the load currents representing how much current from the renewable energy system and a power utility is presently being consumed at the home at various points of interest therein. The computer-readable instructions, when executed by the processor, additionally cause the PCS to perform a process that determines that the load currents at the home exceed a predefined threshold(s), and perform a process that minimizes a charging current of the renewable energy system in response to the load currents exceeding the predefined threshold(s). The computer-readable instructions, when executed by the processor, also cause the PCS to perform a process that determines that the load currents continue to exceed the predefined load thresholds, and perform a process that increments a discharge current of the renewable energy system in response to the load currents continuing to exceed the predefined load thresholds. The computer-readable instructions, when executed by the processor, further cause the PCS to perform a process that determines that the load currents still exceed the predefined threshold(s), and perform a process that electrically disconnects the renewable energy system from the power utility in response to the load currents still exceeding the predefined load thresholds.

In general, in another aspect, embodiments of the present disclosure relate to a method of controlling power for a renewable energy system at a home. The method comprises, among other things, obtaining, by a power control system (PCS), load currents at the home, the load currents representing how much current from the renewable energy system and a power utility is presently being consumed at the home at various points of interest therein. The method additionally comprises determining, by the PCS, that the load currents at the home exceed a predefined threshold(s), and minimizing, by the PCS, a charging current of the renewable energy system in response to the load currents exceeding the predefined threshold(s). The method also comprises determining, by the PCS, that the load currents continues to exceed the predefined threshold(s), and incrementing, by the PCS, a discharge current of the renewable energy system in response to the load currents continuing to exceed the predefined threshold(s). The method further comprises determining, by the PCS, that the load currents still exceed the predefined threshold, and disconnecting, by the PCS, the renewable energy system from the power utility in response to the load currents still exceeding the predefined threshold(s).

In general, in yet another aspect, embodiments of the present disclosure relate to a solar and storage power system at a home. The solar and storage power system comprises, among other things, solar power modules and an inverter connected to the solar power modules. The inverter is configured to convert current generated by the solar power modules for use at the home, and includes either a hybrid inverter, a string inverter, or both. The solar and storage power system also comprises a battery connected to the inverter, the battery configured to input a charging current from the inverter and to output a discharging current to the inverter. The battery includes either a stationary battery, a mobile battery, or both. The inverter is additionally configured to obtain load currents at the home, the load currents representing how much current from the solar and storage power system and a power utility is presently being consumed at the home at various points of interest therein. The inverter is also configured to determine that the load currents at the home exceed a predefined threshold(s), and minimize a charging current of the solar and storage power system in response to the load currents exceeding the predefined threshold(s). The inverter is further configured to determine that the load currents continue to exceed the predefined threshold(s), and increment a discharge current of the solar and storage power system in response to the load currents continuing to exceed the predefined load threshold. The inverter is still further configured to determine that the load currents still exceed the predefined threshold(s), and disconnect the solar and storage power system from the power utility in response to the load currents still exceeding the predefined threshold(s).

In accordance with any one or more of the foregoing embodiments, the PCS obtains a utility non-backed-up load current at the home on a continuous basis, the utility non-backed-up load current representing how much current from the power utility is presently being consumed at the home after the renewable energy system has been electrically disconnected from the power utility, and obtains a backed-up load current at the home on a continuous basis, the backed-up load current representing how much current from the renewable energy system is presently being consumed at the home after the renewable energy system is electrically disconnected from the power utility.

In accordance with any one or more of the foregoing embodiments, the PCS determines that the utility non-backed-up load current and the backed-up load current are below the predefined threshold(s), and connects the renewable energy system to the power utility in response to the utility non-backed-up load current and the backed-up load current being below the predefined threshold(s).

In accordance with any one or more of the foregoing embodiments, the PCS obtains source currents at the home on a continuous basis, the source currents representing how much current from the renewable energy system and the power utility is presently being sourced to the home at various points of interest therein, and determines that the source currents at the home exceed the predefined threshold(s), minimizes a discharging current of the renewable energy system in response to the source currents exceeding the predefined threshold(s). In accordance with any one or more of the foregoing embodiments, the PCS also determines that the source currents continue to exceed the predefined threshold(s), and increments a charge current of the renewable energy system in response to the source currents continuing to exceed the predefined threshold(s). In accordance with any one or more of the foregoing embodiments, the PCS further determines that the source currents still exceed the predefined threshold(s), and disconnects the renewable energy system from the power utility in response to the source currents continuing to exceed the predefined threshold(s).

In accordance with any one or more of the foregoing embodiments, the PCS obtains a utility source current at the home on a continuous basis, the utility source current representing how much current from the power utility is presently being sourced at the home after the renewable energy system has been electrically disconnected from the power utility, and obtains a renewables source current at the home on a continuous basis, the renewables source current including total inverter excess production representing how much current from the renewable energy system can potentially be sourced at the home after the renewable energy system is electrically disconnected from the power utility.

In accordance with any one or more of the foregoing embodiments, the PCS determines that the utility source current and the renewables source current are below the predefined threshold(s), and connects the renewable energy system to the power utility in response to the utility source current and the renewables source current being below the predefined threshold(s).

In accordance with any one or more of the foregoing embodiments, the renewable energy system is a solar and storage power system.

In general, in yet another aspect, embodiments of the present disclosure relate to a method of controlling power for a renewable energy system at a home. The method comprises, among other things, obtaining, by a power control system (PCS), source currents at the home, the source currents representing how much current from the renewable energy system and a power utility is presently being sourced to the home at various points of interest therein, and determining, by the PCS, that the source currents at the home exceed the predefined threshold(s) and minimizing a discharging current of the renewable energy system in response to the source currents exceeding the predefined threshold(s). The method also comprises determining, by the PCS, that the source currents continue to exceed the predefined threshold(s) and incrementing a charge current of the renewable energy system in response to the source currents continuing to exceed the predefined threshold(s). The method further comprises determining, by the PCS, that the source currents still exceed the predefined threshold(s) and disconnecting the renewable energy system from the power utility in response to the source currents continuing to exceed the predefined threshold(s).

In general, in yet another aspect, embodiments of the present disclosure relate to a power control system (PCS) for a renewable energy system at a home. The PCS comprises, among other things, a processor and a storage unit coupled to the processor. The storage unit stores computer-readable instructions thereon that, when executed by the processor, cause the PCS to perform a method according to any one or more of the foregoing embodiments.

### BRIEF DESCRIPTION OF THE DRAWINGS

FIG. 1 illustrates an exemplary system for controlling a renewable energy system in a home or residential dwelling according to embodiments of the present disclosure;

FIG. 2 illustrates an exemplary method for controlling a renewable energy system in a home or residential dwelling according to embodiments of the present disclosure;

FIG. 3 illustrates an alternative exemplary system for controlling a renewable energy system according to embodiments of the present disclosure;

FIG. 4 illustrates another exemplary system for controlling a renewable energy system according to embodiments of the present disclosure;

FIG. 5 illustrates yet another exemplary system for controlling a renewable energy system according to embodiments of the present disclosure;

FIG. 6 illustrates an exemplary computing system that may be used for the power control system (PCS) controller according to embodiments of the present disclosure; and

FIG. 7 illustrates an exemplary storage system that may be used for the PCS controller according to embodiments of the present disclosure.

### DETAILED DESCRIPTION

This description and the accompanying drawings illustrate exemplary embodiments of the present disclosure and should not be taken as limiting, with the claims defining the scope of the present disclosure, including equivalents. Various mechanical, compositional, structural, electrical, and operational changes may be made without departing from the scope of this description and the claims, including equivalents. In some instances, well-known structures and techniques have not been shown or described in detail so as not to obscure the disclosure. Further, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment.

As alluded to above, a problem that can arise with solar and storage power systems is that the solar power added to the grid power along with new modern loads like heat pumps, EV chargers, and the like can overload the home electrical panel and/or busbar conductors. Most electrical panels and busbars are sized, or rated, when installed to ensure sufficient current carrying capacity to simultaneously power all typical loads. When a solar and storage power system is later added to the home, the additional power available for consumption can cause the current in the electrical panel and busbars to increase beyond their ratings and cause them to operate in an “overload” condition during abnormal scenarios like a short circuit, for example. This overload condition can further occur during normal operating condition when subsequent loads are added to the home, especially large loads, such as an EV charger, heat pump, and the like. If left unresolved, the overload condition can cause either overload in a busbar leading to overheating and potential safety/fire hazard or cause an overcurrent protection device (OCPD) in the electrical panel, typically a circuit breaker, to “trip” and interrupt or cut off grid power.

One way to prevent unwanted trips, or nuisance trips, is to upgrade the electrical panel either by installing a new, higher-rated electrical panel, or by increasing the size (i.e., handle rating) of the circuit breaker in the existing panel. However, installing a new panel or replacing the main breaker in an existing panel can be a costly endeavor, usually requiring a certified electrician or other specially trained personnel to perform the installation or expansion. As well, such installation or expansion usually requires structural changes to walls and ceilings, especially for older homes, in order to accommodate new utility service lines and the like for the higher rating, which can further increase cost and complications.

Accordingly, embodiments of the present disclosure provide systems and methods for controlling residential renewable energy systems, such as a home solar and storage power system, to resolve or avoid overload conditions that may arise. In some embodiments, in case of excessive load current being drawn by one or more loads in the home (i.e., an overload condition), the disclosed systems and methods maximize load uptime by introducing forced discharge power from the solar and storage power system to help power the loads. This is achieved by decreasing charge to a battery of the solar and storage power system and increasing discharge from the battery while the solar and storage power system is operating in grid-tie mode. The power provided to the one or more loads from the increased battery discharge prevents the loads from being automatically shed (e.g., due to installed branch smart relays/breakers circuits) from the home due to too much power being drawn from the grid. In this way, the forced increased discharge from the battery works to supplement typical self-consumption and time-of-use functions of the solar and storage power system.

Also, in case of excessive power production from the solar and storage power system, for example, from a string inverter of the solar and storage power system, that could cause an overload condition to arise, the systems and methods herein reroute the excess production to the battery instead of back-feeding the production to the grid. This is achieved by controlling a hybrid inverter of the solar and storage power system to reduce discharge from the battery and increase charge to the battery using the excess production. The reduced discharge and increased charge help prevent the overload condition from arising as a result of the excessive power production. In addition, the systems and methods can also control the solar and storage power system to reduce the amount of current in the one or more busbars or other conductors by putting the system into intentional “islanded” mode. This is achieved by intentionally opening an MID or similar switching device of the solar and storage power system to preemptively isolate the system from the grid to prevent an overload condition. If there are smart relays or smart breakers installed in the home, then at this point, the systems and methods may control the smart relays or smart breakers to shed loads as needed to prevent overload to inverter powering the intentional island.

The above systems and methods allow the solar and storage power system to work in a closed-loop manner with a home electrical panel, with the panel, busbar, or other conductor rating or current limit being used as a setpoint for controlling the solar and storage power system, as well as in parallel with existing solar and storage power system functionality like self-consumption, time-of-use, and export limitation. Furthermore, the systems and methods use the MID or similar switching device of the solar and storage power system in an unconventional way. In a typical solar and storage power system, the MID is used only to transition the system to backup or “island” mode when a grid outage occurs. However, in the systems and methods disclosed herein, the MID or similar switching device is used preemptively (i.e., without occurrence of a grid outage) to disconnect a portion of the home (i.e., the portion containing backed-up loads) from the grid, thereby reducing the amount of current in one or more of the busbars or other conductors. In this way, the MID itself can be viewed as a controlled conductor having a 0-Amp setpoint, as the current flowing through the MID is zero when the MID is open. This significantly simplifies NEC load and source calculations for home rating purposes, as loads and sources downstream from the MID shall not impact the load and source calculations.

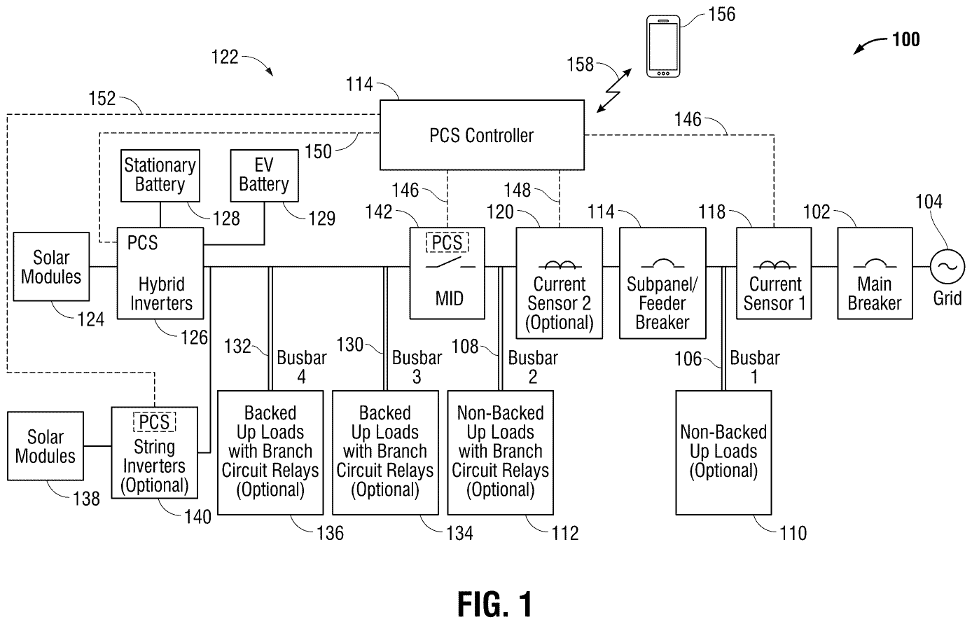

Referring now to FIG. 1, an exemplary system 100 (and method therefor) is shown for controlling a renewable energy system in a home or residential dwelling according to embodiments of the present disclosure. As can be seen, the system 100 includes a main breaker 102, typically housed within an electrical panel (not expressly shown), that connects the home to a power utility or grid 104 via utility service lines. First and second main busbars 106 and 108, labeled “Busbar 1” and “Busbar 2,” respectively, are connected to the main breaker 102 in parallel with each other, and one or more branch loads 110 and 112 are in turn connected to each busbar 106 and 108, respectively, as shown. An optional subpanel/feeder breaker 114, typically housed within a subpanel (not expressly shown), is connected to the main breaker 102 between the first busbar 106 and the second busbar 108, as shown. A main current sensor 118, labeled “Current Sensor 1,” is positioned to measure the current flowing from and to the main breaker 102, and an optional subpanel current sensor 120, labeled “Current Sensor 2,” is positioned to measure the current flowing from and to the subpanel/feeder breaker 114.

In the example of FIG. 1, a solar and storage power system 122 has been installed to provide backup power to the home, for example, in the event the power grid 104 experiences an outage. Although a solar and storage power system is shown, the systems and methods herein are equally applicable to other types of renewable energy systems, such as wind power systems, or combinations thereof. The solar and storage power system 122 shown here is a typical backup power system insofar as there are one or more solar modules 124 connected to one or more hybrid inverters 126 that are in turn connected to at least one stationary battery 128 and/or EV battery 129. Third and fourth busbars 130 and 132, labeled “Busbar 3” and “Busbar 4,” respectively, are connected to the hybrid inverters 126 in parallel with each other (and with the first and second busbars 130 and 132), and one or more branch loads 134 and 136 are in turn connected to each busbar 130 and 132, respectively, as shown. In some embodiments, the solar and storage power system 122 may include one or more additional solar modules 138, and one or more string inverters 140 (instead of the hybrid inverters 126) may be used to connect the additional solar modules 138 to the third and fourth busbars 130 and 132. A microgrid interconnect device (MID) 142 or similar switching device (e.g., automatic transfer switch) is connected to the hybrid inverters 126 and operates to electrically connect and disconnect the solar and storage power system 122 from the power grid 104 in the event of a grid outage.

The above solar and storage power system components are generally well known to those having ordinary skill in the art and therefore a detailed description is omitted here for economy. Suffice it to say, the solar modules 124 and 138 are typically composed of arrays of photovoltaic materials that convert sunlight into electrical current. The string inverters 140 operate to convert the electrical current from the solar modules 138 from DC to AC so the current can be used by downstream loads. The hybrid inverters 126 can likewise convert the electrical current from the solar modules 124 from DC to AC for downstream loads, but can also use the current from the solar modules 124 to charge the battery 128. Hybrid inverters 126 can source current from stationary battery 128 and/or EV battery 129 to supply house loads along with power from solar modules 124. Moreover, the hybrid inverters 126 are configured to allow the solar and storage power system 122 to be used in both grid-tie mode and off-grid mode by selectively causing the MID 142 to connect or disconnect the solar and storage power system 122 from the grid 104 as needed.

In basic operation, when the MID 142 is closed, current from the grid 104 flows through the main breaker 102 to the busbars 106, 108, 130, and 132 and out to the one or more loads 110, 112, 134, and 136, respectively, to power the loads. When the MID 142 is thusly closed, the solar and storage power system 122 is considered to be in grid-tie mode, and the typical battery charge, self-consumption, and time-of-use functions of the solar and storage power system 122 operate as intended. When a grid outage is detected, the MID 142 automatically opens to disconnect the solar and storage power system 122 from the grid 104, thereby putting the solar and storage power system in backup mode. In backup mode, also called “island” mode, current generated by the solar and storage power system 122 as well as charge stored in the batteries 128/129 begin flowing through the third and fourth main conductors 130 and 132 and out to their respective loads 134 and 136, respectively, thereby continuing to power these loads. Hence, these loads 134 and 136 are considered to be backed-up loads, whereas the loads 110 and 112 of the first and second busbars 106 and 108 are considered to be non-backed-up loads.

In accordance with embodiments of the present disclosure, a power control system (PCS) controller 144 is provided in the system 100 for providing real-time monitoring and control of the solar and storage power system 122. The PCS controller 144 may be implemented in the system 100 as software/firmware (e.g., processor-executable code), or hardware (e.g., ASIC, FPGA, etc.). To this end, the PCS controller 144 may reside on or be downloaded to the MID 142 in some embodiments, one or more of the hybrid inverters 126 in some embodiments, or a combination of both. In the latter case, a portion of the PCS controller 144, such as the main software program, may reside on the MID 142, and a portion of the PCS controller 144, such as one or more software agents, may reside on one or more of the hybrid inverters 126 (see dashed line box), or vice versa. In either case, the PCS controller 144 may then send and/or receive control and/or data signals to and/or from various components of the system 100, including the main current sensor 118 (via an appropriate communication link 146), the optional subpanel current sensor 120 (via an appropriate communication link 148), the one or more hybrid inverters 126 (via an appropriate communication link 150), and the one or more optional string inverters 140 (via an appropriate communication link 152). In a similar manner, users can connect to, and configure the PCS controller 144 via an app or browser running on a smart phone or other mobile device 156 (via an appropriate communication link 158).

The disclosed PCS controller 144 provides a number of advantages and benefits over existing solutions. For example, unlike existing solutions that automatically shed individual branch loads when an overload condition arises in one of the conductors without considering availability of battery current sources, the PCS controller 144 herein, controls hybrid inverter 126 in both import and export directions to avoid automatic disconnection of branch circuit relays/breakers located in panels 110, 112 or 134 and/or tripping the main and subpanel/feeder breakers 102 and 114. This increases hose loads uptime during overload conditions in grid-tie mode. Moreover, the PCS controller 144 herein, can open/close the MID 142 based on conductor(s) current and enter an intentional islanding or backup mode in response to overload conditions and serve as safety disconnect.

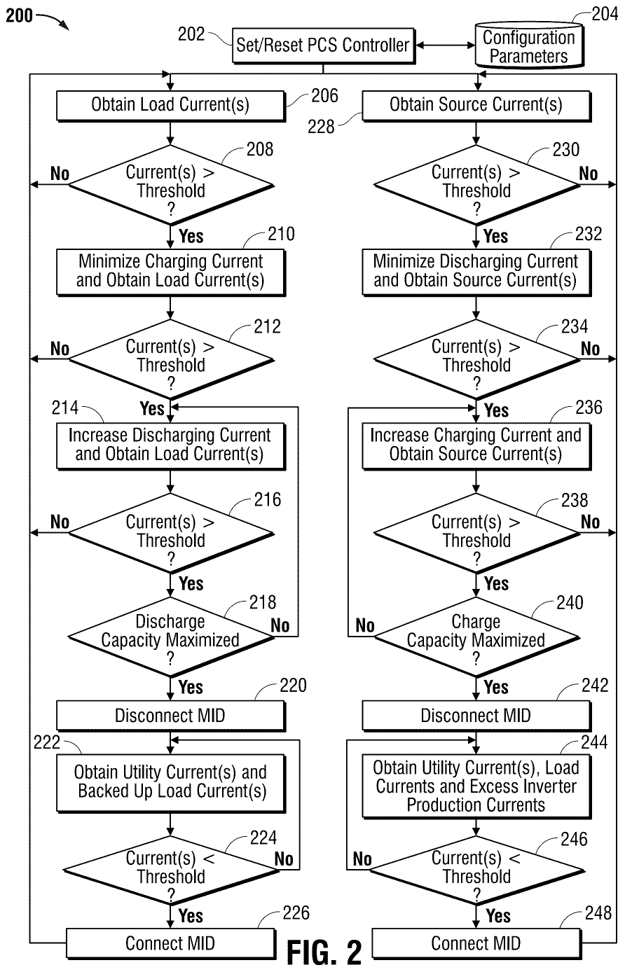

Turning now to FIG. 2, a flowchart 200 is shown representing a method that may be used by or with the PCS controller 144 in accordance with embodiments of the present disclosure. In particular, when the power consumed by the one or more non-backed-up loads 110 and 112 and backed-up loads 134 and 136 is high, current through the main breaker 102 and the subpanel/feeder breaker 114 (if present) may exceed their capacity ratings (i.e., an overload condition), which could lead to tripping of the breakers. To this end, the PCS controller 144 is configured to monitor the amount of load currents via the current sensors 118 and 120 to see if the load currents exceed a selected threshold, which may be, for example, a breaker trip limit, the smallest main conductor rating, or the like. As one example, for a home having an electrical panel rated at 200 Amps, the selected threshold may be a selectable percentage of the panel rating, such as 70 percent, 80 percent, 90 percent, and so on, of the rating.

The method begins at block 202 where the PCS controller 144 is set/reset or otherwise prepared for operation. As part of this process, the PCS controller may obtain one or more configuration parameters for the system 100, or otherwise establish one or more configuration parameters based on the obtained configuration parameters. In some embodiments, the obtained configuration parameters may be acquired from a configuration parameters database 204, which may reside locally with the PCS controller 144, or at a remote location on a network. Such configuration parameters may include, for example, source current thresholds, load current thresholds, circuit breaker ratings, controlled conductors ratings, and any other configuration parameters as needed herein. Alternatively, the PCS controller 144 may prompt a user to enter one or more, or all, of the configuration parameters.

At block 206, the PCS controller 144 measures or otherwise obtains one or more samples of the load currents via the current sensors 118 and 120 (or any other relevant current sensors to measure AC current for a controlled conductor) using a suitable sampling frequency for each sensor. At block 208, the PCS controller 144 makes a determination whether the total amount of current sensed or otherwise measured by either of the current sensors 118 and 120, or both sensors combined, as applicable, exceeds the selected thresholds. If the determination is no, then the PCS controller 144 returns to block 206 and continues monitoring the load currents as discussed above (i.e., via the current sensors 118 and 120). If the determination is yes, meaning one of the selected threshold is exceeded, then the PCS controller 144 begins throttling the hybrid inverters 126 in response.

More specifically, at block 210, the PCS controller 144 controls the hybrid inverters 126 to minimize the amount of current being used to charge the stationary battery 128 and/or EV battery 129 so more current is available for use by the loads 110, 112, 134, and/or 136, and again measures or otherwise obtains one or more samples of the load currents via the current sensors 118 and 120. At block 212, the PCS controller 144 makes another determination whether the load currents still exceed the selected thresholds. If the determination is no, then the PCS controller 144 returns to block 206 and continues monitoring the load currents as discussed above (i.e., via the current sensors 118 and 120). If the determination is yes, meaning minimizing charge current did not immediately (or within a preset amount of time) decrease the load currents below the selected threshold, then at block 214, the PCS controller 144 controls the hybrid inverters 126 to increase the amount of discharge from the stationary battery 128, EV battery 129, or solar panels 124 by a specified increment, thereby making even more current available for use by the various loads 110, 112, 134, and/or 136.

At block 216, the PCS controller 144 makes a further determination whether the load currents still exceed the selected threshold. If the determination is no, then the PCS controller 144 returns to block 206 and continues monitoring the load currents as discussed above. If the determination is yes, meaning incrementing discharge current did not immediately (or within a preset amount of time) decrease the load currents below the selected threshold, then at block 218, the PCS controller 144 determines whether the discharge capacity of the hybrid inverters 126 has been maximized, for example, due to battery discharge current restrictions in grid-tie mode and/or consumption by the backed-up loads 134 (via the branch circuit relays) and 136 (via the branch circuit relays). If the determination is no, then the PCS controller returns to block 214 and again increments the amount of discharge from the battery 128 by a specified amount. If the determination is yes, meaning discharge capacity has been maximized, but the load currents still did not immediately (or within a specified amount of time) drop below the selected threshold, then at block 220, the PCS controller 144 commands the MID 142 to open, thereby forcing transition of the solar and storage power system 122 into intentional islanding or backup mode while the power grid 104 is still present (i.e., without a power outage). It should be noted at block 218 that if the hybrid inverter 126 cannot provide any more discharge current, then this means the discharge capacity of the hybrid inverter 126 has been maximized and there is no need to perform this check, such that block 218 may be omitted.

At block 222, the PCS controller 144 captures the non-backed-up load current via the current sensors 118 and 120 after the transition to backup mode. The non-backed-up load current in one part of the home after the transition to backup mode is limited to the current that is provided exclusively by the power grid. The PCS controller 144 also captures backed-up load current that dropped off the power grid 104 after the transition to backup mode. This backed-up load current is equal the amount of current being consumed by the backed-up loads 134 and 136 at the time the transition occurred. The backed-up load current can be derived via the hybrid inverters 126, which generally behave as voltage sources, and thus are forced to discharge an amount of current equal to the backed-up load current, minus whatever current was being contributed to the backed-up loads 134 and 136 by the string inverters 140. Meanwhile, the power grid 104 continues to power the non-backed-up loads 110 and 112 (if present), such that the home is effectively divided into two parts, each part being powered by an independent power source.

In the intentional islanding/backup mode, the PCS controller 144 continues to monitor the amount of current being consumed by the non-backed-up loads 110 and 112 as well as the backed-up loads 134 and 136. To this end, the PCS controller 144 makes a still further determination at block 224 whether the total load currents, which now includes the load currents from the power grid 104 and the backed-up loads currents, have immediately (or within a specified amount of time) dropped below the selected thresholds. If the determination is no, then the PCS controller 144 returns to block 222 and continues monitoring the load currents. If the determination is yes, meaning the load currents have now returned to a non-overload condition, then at block 226, the PCS controller 144 commands the MID 142 to close, thereby transitioning the solar and storage power system 122 back into grid-tie mode.

In parallel with the above, the PCS controller 144 is also configured to monitor whether the amount of currents being provided to the home by the sources, including the solar and storage power system 122 and the current from the power grid 104, is higher than a selected threshold for a certain controlled conductor. In particular, when the current being provided by the various sources at home are high, current through the main breaker 102, subpanel/feeder breaker 114, and the busbars 106, 108, 130, and/or 132 may exceed their ratings (i.e., an overload condition), which could lead to tripping of the breakers or overloading of one or more busbars or other controlled conductor. To this end, the PCS controller 144 is configured to monitor the source currents being provided to the home by calculating the current being provided to the first busbar 106 (i.e., Busbar 1) as a sum of the currents measured via the main current sensor 118 and the subpanel current sensor 120. In addition, the PCS controller 144 is configured to calculate the current being provided to the second, third, and fourth main conductors 108, 130, and 132 (i.e., Busbar 2, 3 and 4, respectively) as a sum of the currents measured via the subpanel current sensor 120 and the hybrid inverters 126 as well as string inverter 140. This latter calculation is considered to be a “conservative calculation” because the PCS controller 144 does not have an exact measure of the currents being provided to these main conductors 108, 130, and/or 132. The PCS controller 144 may then use these two calculations independently for controlling total source current through controlled conductors not to exceed selected current thresholds, which may be a breaker trip limit, the smallest busbar rating, or the like. As an example, for a home having an electrical panel rated at 100 Amps, the selected threshold for busbar 106 and/or main breaker 102 may be a selectable percentage of the panel rating, such as 110 percent, 120 percent, 130 percent, and so on, of the rating.

Referring still to FIG. 2, at block 228, the PCS controller 144 measures or otherwise obtains one or more samples of the source currents being provided to the main conductors 106, 108, 130, and/or 132 (i.e., Busbars 1, 2, 3, and/or 4) as discussed above via the current sensors 118 and 120 and the hybrid inverters 126 along with string inverters 140 using a suitable sampling frequency for each. At block 230, the PCS controller 144 makes a determination whether the source currents obtained or otherwise measured or estimated exceed the selected thresholds. If the determination is no, then the PCS controller 144 returns to block 228 and continues monitoring the source currents as discussed above. If the determination is yes, then the PCS controller 144 begins throttling the hybrid inverters 126 in response.

More specifically, at block 232, the PCS controller 144 controls the hybrid inverters 126 to minimize the amount of discharge current from stationary battery 128, EV battery 129, or solar modules 124 so less current is provided to the loads 110, 112, 134, and/or 136, and again measures or otherwise obtains one or more samples of the source currents via the current sensors 118 and 120 and the hybrid inverters 126. At block 234, the PCS controller 144 makes another determination whether the source currents still exceed the selected thresholds. If the determination is no, then the PCS controller 144 returns to block 228 and continues monitoring the source currents as discussed above (i.e., via the current sensors 118 and 120 and the hybrid inverters 126). If the determination is yes, meaning minimizing discharge current did not immediately (or within a present amount of time) decrease the source currents below the selected source threshold, then at block 236, the PCS controller 144 controls the hybrid inverters 126 to increase the amount of charge to the battery 128 by a specified increment, thereby making even less current available for use by the various loads 110, 112, 134, and/or 136.

At block 238, the PCS controller 144 makes a further determination whether the source currents still exceeds the selected source threshold. If the determination is no, then the PCS controller 144 returns to block 228 and continues monitoring the source currents as discussed above. If the determination is yes, meaning incrementing charge current did not immediately (or within a present amount of time) decrease the source currents below the selected source threshold, then at block 240, the PCS controller 144 determines whether the charge capacity of the battery 128 has been maximized, for example, due to excess current production from the string inverters 140 which cannot be further redirected into the hybrid inverters 126. If the determination is no, then the PCS controller returns to block 236 and again increments the amount of charge to the stationary battery 128 or EV battery by a specified amount. If the determination is yes, meaning charge capacity has been maximized, but the source currents still did not immediately (or within a specified amount of time), drop below the selected thresholds, then at block 242, the PCS controller 144 commands the MID 142 to open, thereby forcing transition of transitioning the solar and storage power system 122 into intentional islanding or backup mode while the power grid 104 is still present (i.e., without a power outage). It should be noted at block 240 as well that if the hybrid inverter 126 cannot take any more charge current, then this means the charge capacity of the hybrid inverter 126 has been maximized and there is no need to perform this check, such that block 240 may be omitted.

At block 244, the PCS controller 144 takes a snapshot or otherwise captures the source currents immediately after (and also before) the transition via the current sensors 118 and 120 and the hybrid inverters 126 as well as string inverters 140. The source currents in the non-backed up part of the home, after the transition to backup mode, is limited to the current that is provided exclusively by the power grid and matches the non-backed up loads 110/112. The source currents in the backed-up part of the home, after the transition to backup mode, is limited to the current that is provided exclusively by the inverters 126 and 140, and matches the backed-up loads 134/136. The PCS controller 144 calculates the “total excess inverter production” current that dropped off after the transition to backup mode as a difference of sources current before and after transition to island mode provided by the hybrid inverters 126 and string inverter 140. Meanwhile, the power grid 104 continues to power the non-backed-up loads 110 and 112 (if present), such that the home is now split into two parts which are being supplied by independent sources.

In the intentional islanding mode, the PCS controller 144 continues to monitor the current production from the power grid 104 via the main current sensor 118 and the subpanel current sensor 120 (if present), as well as the current production from the solar and storage power system 122 via the hybrid inverters 126 and string inverter 140. The latter includes added “total excess inverter production” current that was being provided before the transition to backup mode. To this end, the PCS controller 144 makes a still further determination at block 246 whether the source currents, which now include the source currents from the power grid 104 and the hybrid inverters 126 along with string inverters 140 plus “excess inverter production” current, have immediately (or within a specified amount of time) dropped below the selected source threshold. If the determination is no, then the PCS controller 144 returns to block 244 and continues monitoring the source currents. If the determination is yes, meaning the source currents have now returned to a non-overload condition, then at block 248, the PCS controller 144 commands the MID 142 to close, thereby transitioning the solar and storage power system 122 back into grid-tie mode.

A particular advantage of the PCS controller 144 according to the embodiments herein is by opening the MID 142 (or similar switching device) preemptively (i.e., without a power outage) to disconnect a portion of the home from the grid, the amount of current in one or more of the busbars or other main conductors is reduced. In essence, the MID itself acts as a controlled conductor having a 0-Amp setpoint, as the current flowing through the MID is zero when the MID is open. This allows for significantly simplified load and source calculations for purposes of satisfying NEC (National Electrical Code) requirements, as loads and sources downstream from the MID do not impact the load and source calculations.

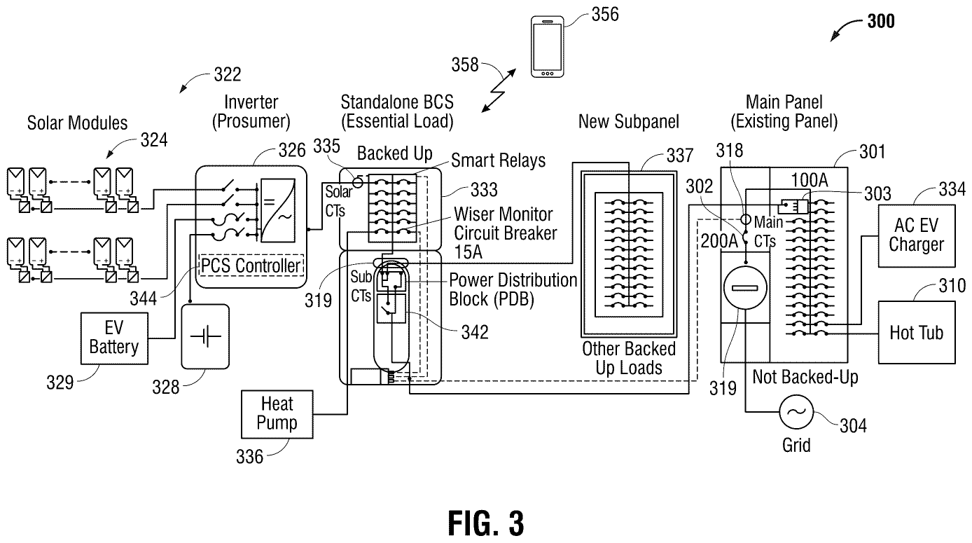

FIG. 3 shows another exemplary system 300 (and method therefor) for controlling a renewable energy system in a home or residential dwelling according to embodiments of the present disclosure. The system 300 resembles the system 100 of FIG. 1, including that there is a main electrical panel 301 housing a main breaker 302 that provides power to various loads in the home, such as a hot tub 310 or AC EV charger 334, from a power utility or grid 304. A main current sensor 318, which may be a current transformer in some embodiments, is installed in the main panel 301 to measure current flowing from and to the panel 301. A main electric meter 319 is also present for measuring the grid power consumed in the home.

A solar and storage power system 322 is also present in the system 300 configured to provide backup power to the home, for example, in the event of a power grid outage. The solar and storage power system 322 shown here is a typical system insofar as there are one or more solar modules 324 connected to a hybrid inverter 326 that is in turn connected to at least one battery 328/329. The hybrid inverter 326 is also connected to a subpanel 333 having a plurality of smart relays that provide power to a plurality of loads, including a heat pump 336, among other loads. A solar current sensor 335, which may be a current transformer in some embodiments, is installed in the subpanel 333 to measure current flowing from and to the subpanel 333, and duplicates measurements provided by hybrid inverter 326. The subpanel 333 is in turn connected to new subpanel 337 for providing power to additional loads in the home. An MID 342 or similar switching device (e.g., automatic transfer switch) connects the subpanel 333 and the new subpanel 337 to the main electrical panel 301. The MID 342 operates to electrically connect and disconnect the solar and storage power system 322 from the power grid 304 in the event of a grid outage. A subpanel current sensor 319, which may be a current transformer in some embodiments, is installed as shown to measure current flowing from and to the MID 342.

In the exemplary system 300, heat pump 336, and other loads that receive current through the second subpanel 333 are backed up by the solar and storage power system 322 and can continue to operate in the event of a grid outage. In contrast, the hot tub 310, AC EV charger 334 and other loads that receive current through the main electrical panel 301 are not backed up and simply lose power in the event of a grid outage. A subpanel/feeder breaker 303 connects current from the main breaker 301 to the subpanel 333, as shown. A PCS controller 344, which may reside in the hybrid inverter 326 in some embodiments, provides real-time monitoring and control of the solar and storage power system 322. The PCS controller 344 operates in a similar manner to the PCS controller 144 from FIG. 1, as discussed in FIG. 2: the PCS controller 344 monitors and measures load currents in the home using the main current sensor 318, and the subpanel secondary current sensor 319. Source currents are measured using the main current sensor 318, subpanel secondary current sensor 319, solar current sensor 335, and the hybrid inverter 326. Users may then connect to, and configure, the PCS controller 344 via an app or browser running on a smart phone or other mobile device 356 (via an appropriate communication link 358).

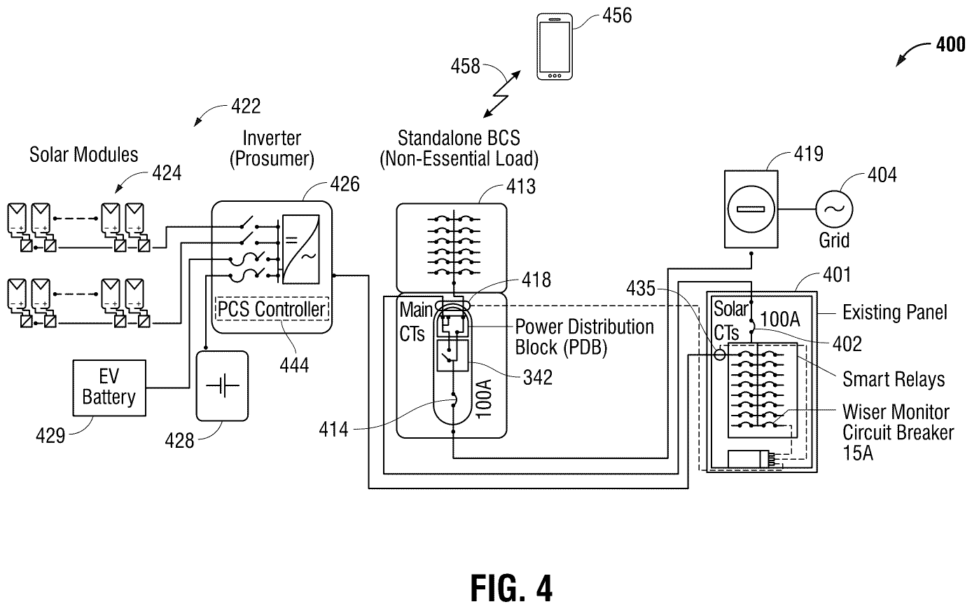

FIG. 4 shows another exemplary system 400 (and method therefor) for controlling a renewable energy system in a home or residential dwelling according to embodiments of the present disclosure. The system 400 again resembles the system 100 of FIG. 1, including that there is main panel 413 connected to the power grid 404 via main breaker 414 bypassing MID 442 and providing power for a plurality of non-essential loads. There is also an electrical subpanel 401 housing a subpanel breaker 402 that provides power to various loads in the home from a power utility or grid 404. In this example, as well, the electrical subpanel 401 has a plurality of smart relays therein and is indirectly connected to the grid 404 through an MID 442 or similar switching device (e.g., automatic transfer switch). The MID 442 thus operates to electrically connect and disconnect the solar and storage power system 422 from the power grid 404 along with subpanel 401 in the event of a grid outage. An electric meter 419 is present for measuring the grid power consumed in the home.

As can be seen, the electrical subpanel 401 also receive power from a solar and storage power system 422 in addition to the power grid 404. The solar and storage power system 422 is again a typical system insofar as there are one or more solar modules 424 connected to a hybrid inverter 426 that is in turn connected to at least one battery 428/429. The hybrid inverter 426 is also connected to the electrical subpanel 401 and provides backup power to the panel 401. A solar current sensor 435, which may be a current transformer in some embodiments, is installed in the electrical subpanel 401 to measure current flowing from and to the solar and storage power system 422 to and from the subpanel 401, and this sensor duplicates measurements provided by hybrid inverter 326. Main current sensor 418, which may be a current transformer in some embodiments, is installed in the MID 442 to measure current flowing from and to the subpanel 401 and the main panel 413.

In the exemplary system 400, loads that receive current through the electrical subpanel 401 are backed up by the solar and storage power system 422 and can continue to operate in the event of a grid outage. In contrast, loads that receive current through the main panel 413 are not backed up and simply lose power in the event of a grid outage. A PCS controller 444, which may reside in the hybrid inverter 426 in some embodiments, provides real-time monitoring and control of the solar and storage power system 422. The PCS controller 444 operates in a similar manner to the PCS controller 144 from FIG. 1, as discussed in FIG. 2: the PCS controller 444 monitors and measures load currents in the home using the main current sensor 418. Source currents are measured using the main current sensor 418, the solar current sensor 435, and the hybrid inverter 426. Users may again connect to, configure the PCS controller 444 via an app or browser running on a smart phone or other mobile device 456 (via an appropriate communication link 458). The only difference between FIG. 1 and FIG. 4 is that this exemplary system 400 does not have subpanel/feeder breaker secondary current sensor.

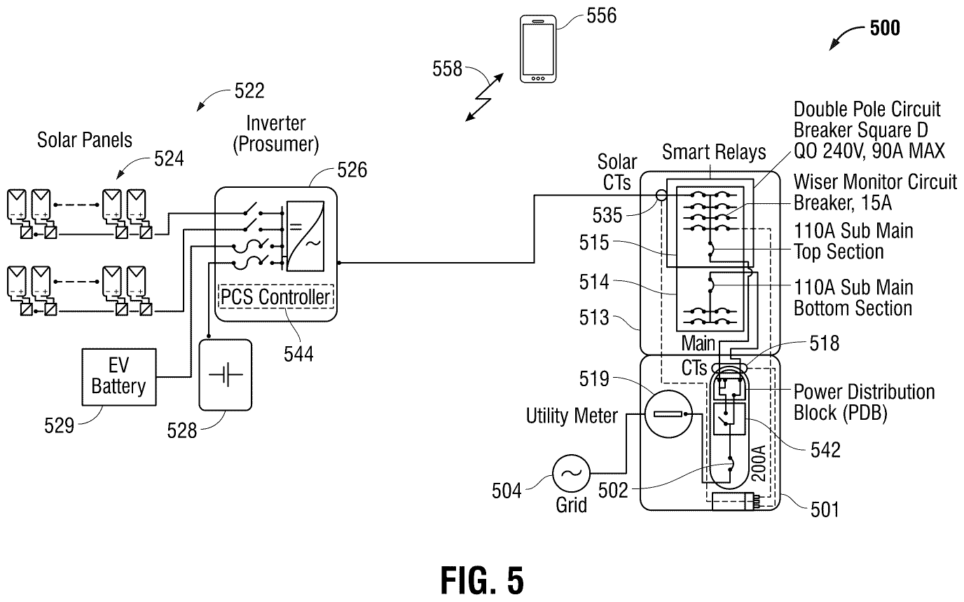

FIG. 5 shows yet another exemplary system 500 (and method therefor) for controlling a renewable energy system in a home or residential dwelling according to embodiments of the present disclosure. The system 500 once again resembles the system 100 of FIG. 1, including that there is a main electrical panel 501 housing a main breaker 502 and panel section 513 that provides power to various loads in the home from a power utility or grid 504. The panel section 513 is housing one subpanel 514 with non-backed-up loads and another subpanel 515 with backed-up loads. In this example, the subpanel 515 has a plurality of smart relays therein and also receives power from a solar and storage power system 522 in addition to the power utility or grid 504. An electric meter 519 is present for measuring the grid power consumed in the home.

The solar and storage power system 522 is once again a typical system insofar as there are one or more solar modules 524 connected to a hybrid inverter 526 that is in turn connected to at least one battery 528/529. The hybrid inverter 526 is also connected to the subpanel 515 and provides backup power to the subpanel 515. A solar current sensor 535, which may be a current transformer in some embodiments, is installed in the subpanel 513 to measure current flowing from and to the solar and storage power system to and from the subpanel 515. An MID 542 or similar switching device (e.g., automatic transfer switch) connects the solar and storage power system to the grid 504 via the subpanel 515 and the main electrical panel 501. The MID 542 operates to electrically connect and disconnect the solar and storage power system 522 along with subpanel 515 from the power grid 504 in the event of grid outage. A production meter 521 may be present to measure the current provided by the solar and storage power system 522 to the grid 504.

In the exemplary system 500, loads that receive current through subpanel 515 are backed up by the solar and storage power system 522 and can continue to operate in the event of a grid outage. In contrast, loads that receive current through the subpanel 514 are not backed up and simply lose power in the event of a grid outage. A PCS controller 544, which may reside in the hybrid inverter 526 in some embodiments, provides real-time monitoring and control of the solar and storage power system 522. The PCS controller 544 operates in a similar manner to the PCS controller 144 from FIG. 1, as discussed in FIG. 2: the PCS controller 544 monitors and measures load currents in the home using the main current sensor 518. Source currents are measured using the main current sensor 518, the solar current sensor 535, and the hybrid inverter 526. Users may once again connect to, configure the PCS controller 544 via an app or browser running on a smart phone or other mobile device 556 (via an appropriate communication link 558). The only difference between FIG. 1 and FIG. 5 is that this exemplary system 500 does not have subpanel/feeder breaker secondary current sensor.

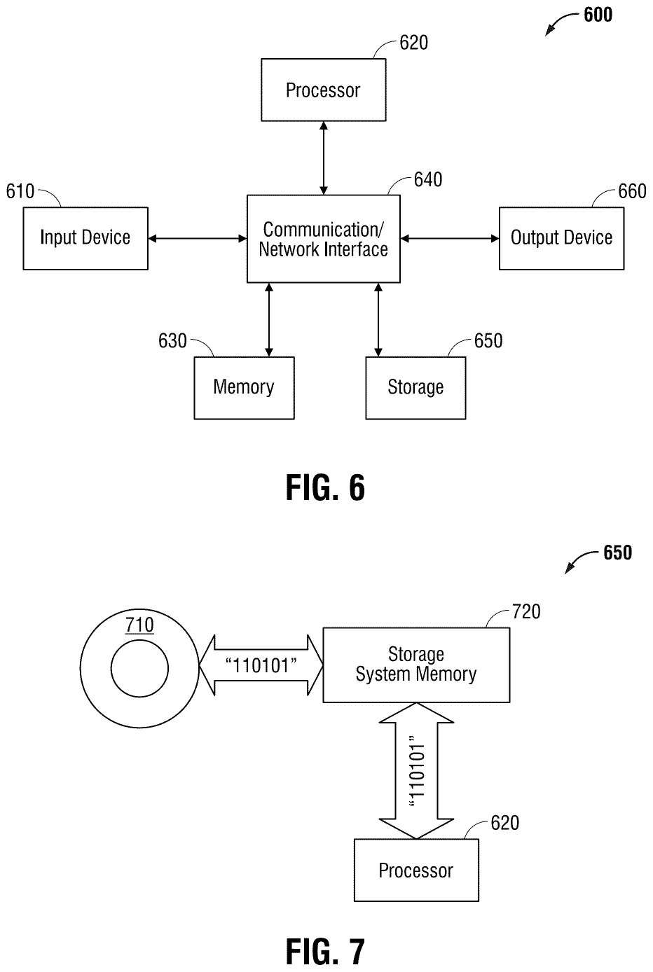

FIG. 6 illustrates an exemplary system that may be used to implement various embodiments of the PCS controller discussed in this disclosure. For example, various embodiments of the disclosure may be implemented as specialized software executing in a computing system 600 such as that shown in FIG. 6. The system 600 may include a processor 620 connected to one or more memory devices 630, such as magnetic or solid sate memory, either embedded and discrete, or other memory devices for storing data. Memory 630 is typically used for storing programs and data during operation of the system 600. The system 600 may also include a storage system 650 that provides additional storage capacity. Components of system 600 may be coupled by a communication interface 640, which may include one or more busses (e.g., between components that are integrated within the same machine) and/or a network interface 640 (e.g., between components that reside on separate discrete machines). The communication/network interface 640 enables communications (e.g., data, instructions) to be exchanged between system components of system 600 and system components of other systems on the network.

System 600 also includes one or more input devices 610, for example, keys, buttons, microphone, touch screen, and one or more output devices 660, for example, a display screen, LEDs, and the like. In addition, system 600 may contain one or more interfaces (not shown) that connect system 600 to a communication network (in addition or as an alternative to the interconnection mechanism 640).

The storage system 650, shown in greater detail in FIG. 7, typically includes a computer readable and writeable nonvolatile recording medium 710 in which signals are stored that define a program to be executed by the processor 620 or information stored on or in the medium 710 to be processed by the program to perform one or more functions associated with embodiments described herein. To this end, the processor 620 may be any suitable processing unit, such as a microprocessor, microcontroller, ASIC, and the like, and the medium any suitable recording medium, such as a magnetic or solid-state memory. Typically, in operation, the processor 620 causes data to be read from the nonvolatile recording medium 710 into storage system memory 720 that allows for faster access to the information by the processor than does the medium 710. This storage system memory 720 is typically a volatile, random access memory such as a dynamic random-access memory (DRAM) or static memory (SRAM). This storage system memory 720 may be located in storage system 650, as shown, or in the system memory 630. The processor 620 generally manipulates the data within the memory system 720 and then copies the data to the medium 710 after processing is completed. A variety of mechanisms are known for managing data movement between the medium 710 and the integrated circuit memory element 720, and the disclosure is not limited thereto. The disclosure is not limited to a particular memory 720, memory 630 or storage system 650.

The system 600 may include specially programmed, special-purpose hardware, for example, an application-specific integrated circuit (ASIC). Aspects of the disclosure may be implemented in software, hardware or firmware, or any combination thereof. Further, such methods, acts, systems, system elements and components thereof may be implemented as part of the system described above or as an independent component.

Although the system 600 is shown by way of example as one type of system upon which various aspects of the disclosure may be practiced, it should be appreciated that aspects of the disclosure are not limited to being implemented on the system as shown in FIG. 6. Various aspects of the disclosure may be practiced on one or more devices having a different architecture or components from that shown in FIG. 6. Further, where functions or processes of embodiments of the disclosure are described herein (or in the claims) as being performed on a processor or controller, such description is intended to include systems that use more than one processor or controller to perform the functions.

In the preceding, reference is made to various embodiments. However, the scope of the present disclosure is not limited to the specific described embodiments. Instead, any combination of the described features and elements, whether related to different embodiments or not, is contemplated to implement and practice contemplated embodiments. Furthermore, although embodiments may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

It will be appreciated that the development of an actual commercial application incorporating aspects of the disclosed embodiments will require many implementation-specific decisions to achieve a commercial embodiment. Such implementation specific decisions may include, and likely are not limited to, compliance with system related, business related, government related and other constraints, which may vary by specific implementation, location and from time to time. While a developer's efforts might be considered complex and time consuming, such efforts would nevertheless be a routine undertaking for those of skill in this art having the benefit of this disclosure.

It should also be understood that the embodiments disclosed and taught herein are susceptible to numerous and various modifications and alternative forms. Thus, the use of a singular term, such as, but not limited to, “a” and the like, is not intended as limiting of the number of items. Similarly, any relational terms, such as, but not limited to, “top,” “bottom,” “left,” “right,” “upper,” “lower,” “down,” “up,” “side,” and the like, used in the written description are for clarity in specific reference to the drawings and are not intended to limit the scope of the invention.

This disclosure is not limited in its application to the details of construction and the arrangement of components set forth in the following descriptions or illustrated by the drawings. The disclosure is capable of other embodiments and of being practiced or of being carried out in various ways. Also, the phraseology and terminology used herein is for the purpose of descriptions and should not be regarded as limiting. The use of “including,” “comprising,” “having,” “containing,” “involving,” and variations herein, are meant to be open-ended, i.e., “including but not limited to.”

The various embodiments disclosed herein may be implemented as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer-readable medium(s) having computer-readable program code embodied thereon.

Any combination of one or more computer-readable medium(s) may be utilized. The computer-readable medium may be a non-transitory computer-readable medium. A non-transitory computer-readable medium may be, for example, but not limited to, an electronic, magnetic, optical, electromagnetic, infrared, or semiconductor system, apparatus, or system, or any suitable combination of the foregoing. More specific examples (a non-exhaustive list) of the non-transitory computer-readable medium can include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage system, a magnetic storage system, or any suitable combination of the foregoing. Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages. Moreover, such computer program code can execute using a single computer system or by multiple computer systems communicating with one another (e.g., using a local area network (LAN), wide area network (WAN), the Internet, etc.). While various features in the preceding are described with reference to flowchart illustrations and/or block diagrams, a person of ordinary skill in the art will understand that each block of the flowchart illustrations and/or block diagrams, as well as combinations of blocks in the flowchart illustrations and/or block diagrams, can be implemented by computer logic (e.g., computer program instructions, hardware logic, a combination of the two, etc.). Generally, computer program instructions may be provided to a processor(s) of a general-purpose computer, special-purpose computer, or other programmable data processing apparatus. Moreover, the execution of such computer program instructions using the processor(s) produces a machine that can carry out a function(s) or act(s) specified in the flowchart and/or block diagram block or blocks.

One or more portions of the computer system may be distributed across one or more computer systems coupled to a communications network. For example, as discussed above, a computer system that determines available power capacity may be located remotely from a system manager. These computer systems also may be general-purpose computer systems. For example, various aspects of the disclosure may be distributed among one or more computer systems configured to provide a service (e.g., servers) to one or more client computers, or to perform an overall task as part of a distributed system. For example, various aspects of the disclosure may be performed on a client-server or multi-tier system that includes components distributed among one or more server systems that perform various functions according to various embodiments of the disclosure. These components may be executable, intermediate (e.g., IL) or interpreted (e.g., Java) code which communicate over a communication network (e.g., the Internet) using a communication protocol (e.g., TCP/IP). For example, one or more database servers may be used to store system data, such as expected power draw, that is used in designing layouts associated with embodiments of the present disclosure.

Various embodiments of the present disclosure may be programmed using an object-oriented programming language, such as SmallTalk, Java, C++, Ada, or C # (C-Sharp). Other object-oriented programming languages may also be used. Alternatively, functional, scripting, and/or logical programming languages may be used, such as BASIC, Fortran, Cobol, TCL, Lua, Python, Rust or basic C. Various aspects of the disclosure may be implemented in a non-programmed environment (e.g., analytics platforms, or documents created in HTML, XML or other format that, when viewed in a window of a browser program render aspects of a graphical-user interface (GUI) or perform other functions). Various aspects of the disclosure may be implemented as programmed or non-programmed elements, or any combination thereof.

The flowchart and block diagrams in the Figures illustrate the architecture, functionality and/or operation of possible implementations of various embodiments of the present disclosure. In this regard, each block in the flowchart or block diagrams may represent a module, segment or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus far, a number of features and advantages of embodiments of the present disclosure have been shown and described. Other possible features and advantages associated with the disclosed embodiments will be appreciated by one of ordinary skill in the art. It should also be understood that embodiments of the disclosure herein may be configured as a system, method, or combination thereof. Accordingly, embodiments of the present disclosure may be comprised of various means including hardware, software, firmware or any combination thereof.

While particular embodiments and applications of the present disclosure have been illustrated and described, it is to be understood that embodiments of the disclosure not limited to the precise construction and compositions disclosed herein and that various modifications, changes, and variations can be apparent from the foregoing descriptions without departing from the spirit and scope of the disclosure as defined in the appended claims.

I/We claim:

1. A power control system (PCS) for a renewable energy system at a home, the power control system comprising:
a processor; and
a storage unit coupled to the processor, the storage unit storing computer-readable instructions thereon that, when executed by the processor, cause the PCS to:
perform a process that obtains load currents at the home, the load currents representing how much current from the renewable energy system and a power utility is presently being consumed at the home at various points of interest therein;
perform a process that determines that the load currents at the home exceed a predefined threshold(s);
perform a process that minimizes a charging current of the renewable energy system in response to the load currents exceeding the predefined threshold(s);
perform a process that determines that the load currents continue to exceed the predefined threshold(s);
perform a process that increments a discharge current of the renewable energy system in response to the load currents continuing to exceed the predefined threshold(s);
perform a process that determines that the load currents still exceed the predefined threshold(s); and
perform a process that electrically disconnects the renewable energy system from the power utility in response to the load currents still exceeding the predefined threshold(s).

2. The system of claim 1, wherein the computer-readable instructions, when executed by the processor, further cause the PCS to:
perform a process that obtains a utility non-backed-up load current at the home on a continuous basis, the utility non-backed-up load current representing how much current from the power utility is presently being consumed at the home after the renewable energy system has been electrically disconnected from the power utility; and
perform a process that obtains a backed-up load current at the home on a continuous basis, the backed-up load current representing how much current from the renewable energy system is presently being consumed at the home after the renewable energy system is electrically disconnected from the power utility.

3. The system of claim 2, wherein the computer-readable instructions, when executed by the processor, further cause the PCS to:
perform a process that determines that the utility non-backed-up load current and the backed-up load current are below the predefined threshold(s); and
perform a process that electrically connects the renewable energy system to the power utility in response to the utility non-backed-up load current and the backed-up load current being below the predefined threshold(s).

4. The system of claim 1, wherein the computer-readable instructions, when executed by the processor, further cause the PCS to:
perform a process that obtains source currents at the home on a continuous basis, the source currents representing how much current from the renewable energy system and the power utility is presently being sourced to the home at various points of interest therein;
perform a process that determines that the source currents at the home exceed the predefined threshold(s);
perform a process that minimizes a discharging current of the renewable energy system in response to the source currents exceeding the predefined threshold(s);
perform a process that determines that the source currents continues to exceed the predefined threshold(s);
perform a process that increments a charge current of the renewable energy system in response to the source currents continuing to exceed the predefined threshold(s);
perform a process that determines that the source currents still exceed the predefined threshold(s); and
perform a process that electrically disconnects the renewable energy system from the power utility in response to the source currents continuing to exceed the predefined threshold(s).

5. The system of claim 4, wherein the computer-readable instructions, when executed by the processor, further cause the PCS to:
perform a process that obtains a utility source current at the home on a continuous basis, the utility source current representing how much current from the power utility is presently being sourced at the home after the renewable energy system has been electrically disconnected from the power utility; and
perform a process that obtains a renewables source current at the home on a continuous basis, the renewables source current including total inverter excess production representing how much current from the renewable energy system can potentially be sourced at the home after the renewable energy system is electrically disconnected from the power utility.

6. The system of claim 5, wherein the computer-readable instructions, when executed by the processor, further cause the PCS to:
perform a process that determines that the utility source current and the renewables source current are below the predefined threshold(s); and
perform a process that electrically connects the renewable energy system to the power utility in response to the utility source current and the renewables source current being below the predefined threshold(s).

7. The system of claim 1, wherein the renewable energy system is a solar and storage power system.

8. A method of controlling power for a renewable energy system at a home, the method comprising:
obtaining, by a power control system (PCS), load currents at the home, the load currents representing how much current from the renewable energy system and a power utility is presently being consumed at the home at various points of interest therein;
determining, by the PCS, that the load currents at the home exceed a predefined threshold(s);
minimizing, by the PCS, a charging current of the renewable energy system in response to the load currents exceeding the predefined threshold(s);
determining, by the PCS, that the load currents continues to exceed the predefined threshold(s);
incrementing, by the PCS, a discharge current of the renewable energy system in response to the load currents continuing to exceed the predefined threshold(s);
determining, by the PCS, that the load currents still exceed the predefined threshold; and
disconnecting, by the PCS, the renewable energy system from the power utility in response to the load currents still exceeding the predefined threshold(s).

9. The method of claim 8, further comprising:
obtaining, by the PCS, a utility non-backed-up load current at the home on a continuous basis, the utility non-backed-up load current representing how much current from the power utility is presently being consumed at the home after the renewable energy system has been electrically disconnected from the power utility; and
obtaining a backed-up load current at the home on a continuous basis, the backed-up load current representing how much current from the renewable energy system is presently being consumed at the home after the renewable energy system is electrically disconnected from the power utility.

10. The method of claim 9, further comprising:
determining, by the PCS, that the utility non-backed-up load current and the backed-up load current are below the predefined threshold(s); and
connecting, by the PCS, the renewable energy system to the power utility in response to the utility non-backed-up load current and the backed-up load current being below the predefined threshold(s).

11. The method of claim 8, further comprising:
obtaining, by the PCS, source currents at the home on a continuous basis, the source currents representing how much current from the renewable energy system and the power utility is presently being sourced to the home at various points of interest therein;
determining, by the PCS, that the source currents at the home exceed the predefined threshold(s);
minimizing, by the PCS, a discharging current of the renewable energy system in response to the source currents exceeding the predefined threshold(s);
determining, by the PCS, that the source currents continue to exceed the predefined threshold(s);
incrementing, by the PCS, a charge current of the renewable energy system in response to the source currents continuing to exceed the predefined threshold(s);
determining, by the PCS, that the source currents still exceed the predefined threshold(s); and
disconnecting, by the PCS, the renewable energy system from the power utility in response to the source currents continuing to exceed the predefined threshold(s).

12. The method of claim 11, further comprising:
obtaining, by the PCS, a utility source current at the home on a continuous basis, the utility source current representing how much current from the power utility is presently being sourced at the home after the renewable energy system has been electrically disconnected from the power utility; and
obtaining, by the PCS, a renewables source current at the home on a continuous basis, the renewables source current including total inverter excess production representing how much current from the renewable energy system can potentially be sourced at the home after the renewable energy system is electrically disconnected from the power utility.

13. The method of claim 12, further comprising:
determining, by the PCS, that the utility source current and the renewables source current are below the predefined threshold(s); and
connecting, by the PCS, the renewable energy system to the power utility in response to the utility source current and the renewables source current being below the predefined threshold(s).

14. The method of claim 8, wherein the renewable energy system is a solar and storage power system.

15. A solar and storage power system at a home, the solar and storage power system comprising:
solar power modules;
an inverter connected to the solar power modules, the inverter configured to convert current generated by the solar power modules for use at the home, wherein the inverter includes either a hybrid inverter, a string inverter, or both;
a battery connected to the inverter, the battery configured to input a charging current from the inverter and to output a discharging current to the inverter, wherein the battery includes either a stationary battery, a mobile battery, or both;
wherein the inverter is further configured to:
obtain load currents at the home, the load currents representing how much current from the solar and storage power system and a power utility is presently being consumed at the home at various points of interest therein;
determine that the load currents at the home exceed a predefined threshold(s);
minimize a charging current of the solar and storage power system in response to the load currents exceeding the predefined threshold(s);
determine that the load currents continue to exceed the predefined threshold(s);
increment a discharge current of the solar and storage power system in response to the load currents continuing to exceed the predefined load threshold;
determine that the load currents still exceed the predefined threshold(s); and
disconnect the solar and storage power system from the power utility in response to the load currents still exceeding the predefined threshold(s).

16. The solar and storage power system of claim 15, wherein the inverter is further configured to:
obtain a utility non-backed-up load current at the home on a continuous basis, the utility non-backed-up load current representing how much current from the power utility is presently being consumed at the home after the solar and storage power system has been electrically disconnected from the power utility; and
obtain a backed-up load current at the home on a continuous basis, the backed-up load current representing how much current from the solar and storage power system is presently being consumed at the home after the solar and storage power system is electrically disconnected from the power utility.

17. The solar and storage power system of claim 16, wherein the inverter is further configured to:
determine that the utility non-backed-up load current and the backed-up load current are below the predefined threshold(s); and
connect the solar and storage power system to the power utility in response to the utility non-backed-up load current and the backed-up load current being below the predefined threshold(s).

18. The solar and storage power system of claim 15, wherein the inverter is further configured to:
obtain source currents at the home on a continuous basis, the source currents representing how much current from the solar and storage power system and the power utility is presently being sourced to the home at various points of interest therein;
determine that the source currents at the home exceed the predefined threshold(s);
minimize a discharging current of the solar and storage power system in response to the source currents exceeding the predefined threshold(s);
determine that the source currents continue to exceed the predefined threshold(s);
increment a charge current of the solar and storage power system in response to the source currents continuing to exceed the predefined threshold(s);
determine that the source currents still exceed the predefined source threshold; and
disconnect the solar and storage power system from the power utility in response to the source currents continuing to exceed the predefined threshold(s).

19. The solar and storage power system of claim 18, wherein the inverter is further configured to:
obtain a utility source current at the home on a continuous basis, the utility source current representing how much current from the power utility is presently being sourced at the home after the solar and storage power system has been electrically disconnected from the power utility; and
obtain a renewables source current at the home on a continuous basis, the renewables source current representing how much current from the solar and storage power system can potentially be sourced at the home after the solar and storage power system is electrically disconnected from the power utility.

20. The solar and storage power system of claim 19, wherein the inverter is further configured to:
determine that the utility source current and the renewables source current are below the predefined threshold(s); and
connect the solar and storage power system to the power utility in response to the utility source current and the renewables source current being below the predefined threshold(s).
